(19) United States
(12) Patent Application Publication
(10) Pub. No.: US 2009/0138305 A1
(43) Pub. Date: May 28, 2009

(54) MANAGEMENT OF A SERVICE PERFORMING STRUCTURE

(76) Inventors: Amip J. Shah, Santa Clara, CA (US); Chandrakant Patel, Fremont, CA (US); Cullen E. Bash, Los Gatos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/237,695

(22) Filed: Sep. 25, 2008

Related U.S. Application Data
(60) Provisional application No. 60/990,438, filed on Nov. 27, 2007.

(51) Int. Cl. G06Q 10/00

(52) U.S. Cl. 705/7

(57) ABSTRACT

In a method of managing a structure configured to perform a service a net power value for implementing the structure is determined. A structure available energy value is calculated from the net power value and a fuel available energy value is calculated from the structure available energy value. The fuel available energy value is a function of the structure available energy value and an environmental sustainability of the structure. In addition, the structure is managed based upon the calculated fuel available energy value.

### CROSS-REFERENCES

The present application has the same Assignee and shares some common subject matter with PCT Application Serial No. PCT/US07/85602 (Attorney Docket No. 200702937-1), entitled “System Synthesis to Meet an Exergy Loss Target Value”, filed on Nov. 27, 2007 and U.S. Provisional Patent Application No. 60/990,438, (Attorney Docket No. 200702978-1), entitled “Designing an Apparatus to Substantially Minimize Exergy Destruction”, filed on Nov. 27, 2007. The disclosures of the above-listed applications are incorporated by reference in their entireties.

### BACKGROUND

There has been a substantial increase in the number of information technology (IT) structures, such as, IT data centers and IT servers. The IT data centers may be defined as locations, for instance, rooms that house computer systems, such as, the IT servers, arranged in a number of racks. The IT structures are typically designed to perform jobs such as, providing Internet services, performing various calculations, and performing computationally intensive operations, such as, graphics rendering operations. To perform these and other jobs, the IT structures are typically configured with a cooling system infrastructure, a power delivery infrastructure, and a networking infrastructure, all of which require power to operate.

The IT structures typically receive power from conventional electricity grids. As such, the delivery costs of many IT services performed by the IT structures are quantified in terms of the energy required from the electricity grids in conjunction with the application of standard electricity grid rates.

Although current methods for calculating delivery costs are sufficient for most IT structures, there remains room for improvement.

### BRIEF DESCRIPTION OF THE DRAWINGS

Features of the present invention will become apparent to those skilled in the art from the following description with reference to the figures, in which:

FIG. 1 shows a simplified block diagram of a management system containing a structure management apparatus, according to an embodiment of the invention;

FIG. 2A shows a flow diagram of a method of managing a structure configured to perform a service, according to an embodiment of the invention;

FIG. 2B shows a flow diagram of a method of managing a structure based upon pricing for services provided by a structure in furtherance to the method depicted in FIG. 2A, according to an embodiment of the invention;

FIG. 2C shows a flow diagram of a method of managing a structure to reduce at least one of an environmental tax and burdened costs associated with implementing a structure in furtherance to the method depicted in FIG. 2A, according to an embodiment of the invention; and

FIG. 3 shows a block diagram of a computing apparatus configured to implement or execute the method depicted in FIGS. 2A-2C, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and system for managing a structure configured to perform a service. In the method and system disclosed herein, the sustainability (or the cost of environmental damage) in performing the service through implementation of the structure is taken into account in managing the structure. The sustainability is quantified in terms of an environmental tax value that comprises a resource metric of the structure in terms of the energy and other resources consumed by the components of the structure. In addition, burdened costs associated with operating the structure are also taken into account in managing the structure. The total cost in performing the service, as discussed herein, therefore, includes a consideration of both the sustainability and the burdened costs.

The total cost in performing the service, as calculated through implementation of the methods and systems disclosed herein, may therefore be lower when renewable energy sources are implemented and higher when non-renewable energy sources, such as, coal, natural gas, etc., are implemented to power the structure, even when the burdened costs remain the same.

In one regard, the total cost is used to determine pricing for services performed by the structure. In this sense, this pricing model disclosed herein is perceivably less volatile as compared with pricing models that rely solely on monetary costs, particularly if the method of energy delivery involves newer energy technologies which may become cost-prohibitive in the absence of government subsidies. Furthermore, due to this stability of the pricing model disclosed herein, it becomes possible to site and/or evaluate a given structure, such as, a data center, irrespective of short-term local energy costs.

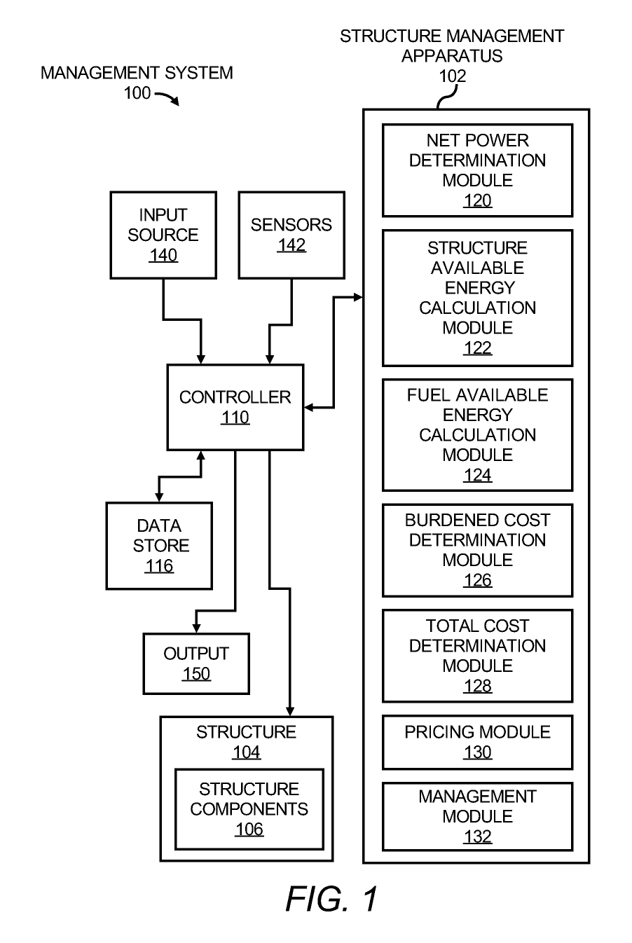

With reference first to FIG. 1, there is shown a simplified block diagram of a management system 100 containing an apparatus 102 for managing a structure 104, according to an example. It should be understood that the management system 100 and the apparatus 102 may include additional elements and that some of the elements described herein may be removed and/or modified without departing from the scope of the management system 100 and the apparatus 102.

The structure 104 may be configured to perform information technology (IT) services, such as, providing Internet services, performing various calculations, performing computationally intensive operations, such as, graphics rendering operations, etc. In this regard, the structure 104 includes a plurality of components 106 that may be implemented to perform the IT services. The plurality of components 106 may comprise one or more components configured to perform the services, such as, servers, processors, disk drives, memories, wiring, etc. In addition, the components 106 may comprise, for instance, a cooling system infrastructure, a power delivery infrastructure, a networking infrastructure, etc. Although the management system 100 is described in terms of an IT data center, it should be understood that the management system 100 may comprise other types of management systems, for instance, management systems for transportation services (such as, hub and spoke airport shuttles, air travel services, and the like), for consumer services (such as, printing services, reservation services, and the like), for public services (such as, weather tracking services, traffic tracking services, and the like), etc., without departing from a scope of the management system 100 disclosed herein.

According to an example, the structure 104 comprises an IT data center housing a plurality of racks on which electronic devices, such as servers, memories, displays, switches, power supplies, etc., are arranged. In this example, the plurality of components 106 that perform or enable performance of the services may include the servers, racks, cooling systems, power supply components, etc., discussed above. By way of particular example, the cooling system infrastructure may comprise a room level air conditioning unit, rack level air conditioning unit, water chiller, heat exchanger, cooling tower, etc.

In another example, the structure 104 comprises a relatively smaller device, such as, an IT server or a processor in an IT server configured to perform IT services. In these examples, the structure components 106 may comprise the structures 104 themselves. In addition, the cooling system infrastructure may comprise, for instance, one or more fans, heat sinks, cold plates connected to refrigeration loops, spray-cooling systems, etc., configured to the cool the structure components 106.

As shown in FIG. 1, the management system 100 includes the structure management apparatus 102, a controller 110, a data store 116, an input source 140, sensors 142, and an output 150. The structure management apparatus 102 is also depicted as including a net power determination module 120, a structure available energy calculation module 122, a fuel available energy calculation module 124, the burdened cost determination module 126, a total cost determination module 128, a pricing module 130, and a management module 132.

As described in greater detail herein below, the structure management apparatus 102, which may comprise software, firmware, or hardware, is generally configured to manage the structure 104 in one or more ways depending upon an environmental sustainability of the structure 104. In instances where the structure management apparatus 102 comprises software, the structure management apparatus 102 may be stored on a computer readable storage medium and may be executed by the processor of a computing device (not shown). In these instances, the modules 120-132 may comprise software modules or other programs or algorithms configured to perform the functions described herein below. In instances where the structure management apparatus 102 comprises firmware or hardware, the structure management apparatus 102 may comprise a circuit or other apparatus configured to perform the functions described herein. In these instances, the modules 120-132 may comprise one or more of software modules and hardware modules, such as, one or more circuits.

The input source 140 may provide a graphical user interface through which a user may provide instructions to the management system 100. In addition, the input received through the input source 140 may be stored in a data store 116 to which the controller 110 is in communication. The data store 116 may comprise a combination of volatile and non-volatile memory, such as DRAM, EEPROM, MRAM, flash memory, and the like. In addition, or alternatively, the data store 116 may comprise a device configured to read from and write to a removable media, such as, a floppy disk, a CD-ROM, a DVD-ROM, or other optical or magnetic media.

The input source 140 may comprise a computing device attached peripherally or over a network to the management system 100 and through which data may be inputted data into the management system 100. Alternatively, however, the management system 100 and the input source 140 may form part of or may be stored in the same computing device. In any regard, the input source 140 may input data pertaining to various characteristics of the structure 104 and/or the structure components 106 into the management system 100. The various characteristics may include, for instance, various burdened costs associated with each of the structure components 104, various environmental damage levels associated with one or more of manufacturing, transporting, implementing, destroying, etc., the structure components 104, etc., which are described in greater detail herein below.

The input source 140 may also supply data pertaining to the price per kilowatt hour of electricity, as well as the amount of energy, for instance, in the form of electricity, supplied into the structure 104. In addition, or alternatively, the amount of energy supplied into the structure 104 may be detected by one or more optional sensors 142. The sensors 142 are considered to be optional because the management system 100 may receive the energy consumption levels directly from the input source 140. In addition, although the input source 140 is depicted as communicating directly with the controller 110, the input source 140 may communicate directly with one or more of the sensors 142 without departing from a scope of the management system 100 in addition or in place of its direct communication with the controller 110.

The input source 140 may further supply data pertaining to environmental tax values associated with implementing the structure 104. The environmental tax values generally comprise resource metrics associated with an environmental sustainability of the structure 104. According to an example, the resource metrics comprise exergy, which is synonymous with available energy and may be defined as a measure of the amount of work a system has the ability of performing. In comparison with energy, which cannot be destroyed because it merely goes from one state to another, exergy is typically destroyed as the system performs work, and thus addresses both energy and material consumption.

More particularly, the second law of thermodynamics necessitates the presence of irreversibilities (or entropy) in any real, physical system. These irreversibilities essentially reduce the amount of work that may be available for utilization by the system. These irreversibilities lead to destruction of available energy or resources (that is, exergy). For example, the process of converting coal into electricity is an irreversible process and the conversion, therefore, corresponds to a destruction of exergy.

According to another example, the resource metrics comprise sustainability estimates other than exergy. In this example, the resource metrics comprise, for instance, tons of carbon dioxide emitted, damage to human health (for instance, in DALY), ecosystem toxicity (for instance, in PDF/m²), etc.

According to a further example, the resource metrics comprise estimates based upon financial market metrics, such as, a sustainability futures index, a commodities index, a sector index, etc.

The structure management apparatus 102, and more particularly, the management module 132 is configured to manage the structure 104 by determining pricing for the services provided through the structure 104, in which the pricing determination includes consideration of the environmental sustainability of the structure 104, in one example. According to another example, the management module 132 is configured to manage the structure 104 by allocating jobs within the structure 104 or among a plurality of structures 104, in which the allocation includes consideration of the environmental sustainability of the structure 104. More particularly, for instance, the management module 132 is configured to manage the structure 104 by allocating jobs among various structure components 106 based upon which of the structure components 106 is associated with the highest environmental sustainability levels. For instance, the management module 132 may allocate jobs to those structure components 106 associated with the highest environmental sustainability levels first and then allocate the remaining jobs to the structure components 106 having the next highest environmental sustainability levels, and so forth. In this regard, the structure components 106 having the highest sustainability levels are utilized first and most often.

According to a further example, the management module 132 is configured to manage the structure 104 by identifying whether one or more components 104 or an environmental tax factor, which is described herein below, may be modified or replaced to reduce at least one of burdened costs associated with the one or more components 104 or the environmental tax factor.

In any regard, the controller 110 may invoke or implement some or all of the modules 120-132 in managing the structure 104 based upon data received from either or both of the input source 140 and the sensors 142. As such, the controller 110 performs a number of processing functions in the management system 100, and may comprise a microprocessor, a micro-controller, an application specific integrated circuit (ASIC), and the like, configured to perform the processing functions.

According to an example, the controller 110 is configured to output 150 data relating to the management decisions made by the management module 132. The output 150 may comprise, for instance, a display configured to display the outputted data, a fixed or removable storage device on which the outputted data is stored, a connection to a network over which the outputted data is communicated, etc.

In another example, the controller 110 is configured to output control signals to one or more of the structure components 106 based upon the decisions made by the management module 132. By way of example, the control signals may include instructions to move a workload from one structure 104 to another structure 104. As another example, the control signals may include instructions to move a workload from one server 106 to another server 106.

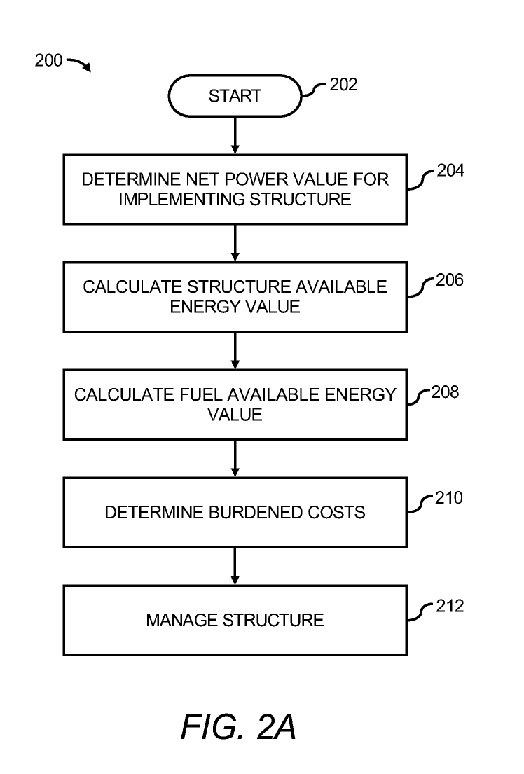

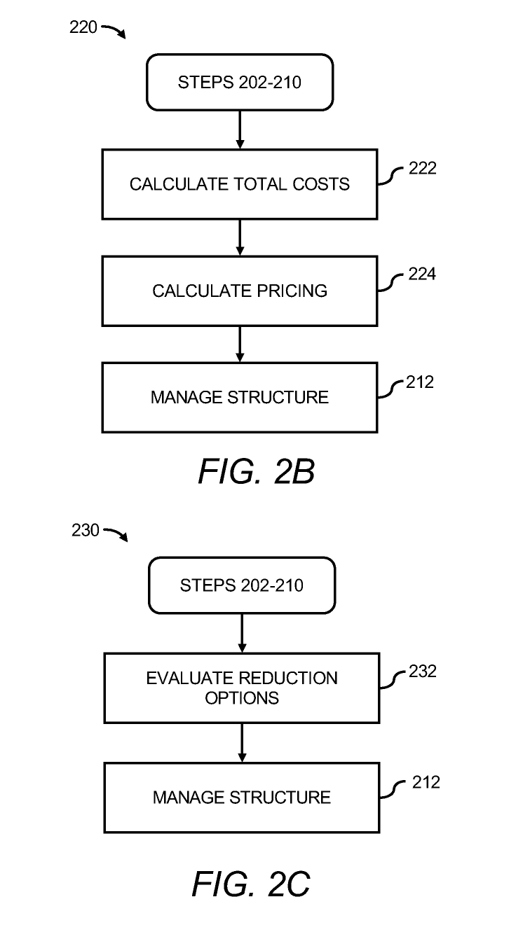

Examples of methods in which the structure management apparatus 102 may be employed to manage a structure 104 based upon a resource metric associated with an environmental sustainability of the structure 104, will now be described with respect to the following flow diagrams of the methods 200, 220, and 230 depicted in FIGS. 2A-2C. It should be apparent to those of ordinary skill in the art that the methods 200, 220, and 230 represent generalized illustrations and that other steps may be added or existing steps may be removed, modified or rearranged without departing from the scopes of the methods 200, 220, and 230.

The descriptions of the methods 200, 220, and 230 are made with reference to the management system 100 illustrated in FIG. 1, and thus makes reference to the elements cited therein. It should, however, be understood that the methods 200, 220, and 230 are not limited to the elements set forth in the management system 100. Instead, it should be understood that the methods 200, 220, and 230 may be practiced by a system having a different configuration than that set forth in the management system 100.

With reference first to FIG. 2A, there is shown a flow diagram of a method 200 of managing a structure 104 configured to perform a service, according to an example. The method 200 may be initiated at step 202, for instance, in response to a direct instruction to perform the method 200, in response to an elapsed period of time, etc. In one regard, therefore, the method 200 may automatically be initiated at various periods of time, following either a predetermined or a random schedule.

Once initiated, the net power determination module 120 determines a net power value for implementing the structure 104. In other words, the net power value for implementing the structure 104 comprises the net power required to run the structure 104, which may include the power required to operate the structure components 106, including, processing equipment, networking equipment, cooling equipment, etc. The net power value (Wₜₒₜ) supplied to the structure 104 may be defined according to the following equation:

Wₜₒₜ=COP_{G}Q_{DC}+Q_{DC}. Equation (1)

In Equation (1), COP_{G} is the coefficient of performance of the ensemble, in this case, the structure 104, and Q_{DC} is the total heat emitted by heat generating components in the structure 104. The total heat emitted (Q_{DC}) is approximately equal to the electricity supplied to the structure 104.

According to the example where the structure 104 comprises an IT data center, the heat generating components may comprise, for instance, servers, hard drives, switches, networking equipment, power supplies, etc., as well as the components housed within the heat generating components. In the example where the structure 104 comprises a server or another smaller electronic device, the heat generating components may comprise the structure 104 itself.

At step 206, the structure available energy calculation module 122 calculates a structure available energy value from the net power value. If the power supplied to the structure 104 is in the form of electricity, this will be mostly available to do work, so the net power value (Wₜₒₜ) supplied over a time period (Δt) will roughly equal the structure available energy (A_{DC}) supplied to the structure 104, as represented by the following equation:

A_{DC}˜WₜₒₜΔt. Equation (2)

In situations where the power supplied to the structure is not entirely available for work, an additional factor (K_{DC}) may need to be included in Equation (2) to compensate for the available energy destroyed during energy conversion. In these cases, the available energy required in the structure may be represented by the following equation:

A_{DC}˜K_{DC}WₜₒₜΔt Equation (2a)

At step 208, the fuel available energy calculation module 124 calculates a fuel available energy value (A_{fuel}). The fuel available energy value (A_{fuel}) generally represents the available energy of the resources required for the generation and transmission of the electricity to the structure 104. This available energy may be normalized with regards to the actual available energy required in the structure, A_{DC}, according to the following equation:

A_{fuel}=K_{fuel}A_{DC}. Equation (3)

In Equation (3), K_{fuel} is an environmental tax value which comprises a resource metric associated with an environmental sustainability of the structure 104. In other words, the resource metric represents that fraction of the fuel available energy (A_{fuel}) which is irreversibly consumed outside the operation of the structure, for instance, during the generation and transmission of the available energy (A_{DC}) to the structure 104. In this sense, the resource metric may be considered as a measure of the amount of environmental damage caused by generation and transmission of energy to the structure 104. The resource metric may be based upon, for instance, exergy, tons of CO₂ emitted, damage to human health, ecosystem toxicity, etc. The resource metric may also be based upon, for instance, a metric based upon financial market metrics, such as, a sustainability futures index, a commodities index, a sector index, etc. The resource metric may further be based upon combinations of two or more of the above-identified resource metrics.

When the environmental tax value (K_{fuel}) is based upon exergy, the environmental tax value (K_{fuel}) may be determined based upon a second-law (exergy) analysis, in which the total available energy destroyed in delivering a service through implementation of the structure 104 is calculated. In this example, the value of the environmental tax value (K_{fuel}) may be based upon, for instance, the amount of exergy lost in converting coal to electricity. The amount of exergy destroyed in generating and delivering the electricity supplied to the structure 104 may be calculated or may be obtained from one or more sources that provide the exergy destruction information for various types of processes and materials. By way of example, the exergy destroyed may be calculated through use of thermodynamic analysis of the resources consumed to generate and deliver the electricity. In any event, this information may be received from the input source 140 and stored in the data store 116.

When the environmental tax value (K_{fuel}) is based upon a carbon footprint of the structure 104, the amount of carbon emitted, for instance, in tons of CO₂, may be detected by the sensors 142 or may be received from the input source 140. When the environmental tax value (K_{fuel}) is based upon a damage to human health, the damage may be estimated in terms of DALY, and may also be measured or received from the input source 140. When the environmental tax value (K_{fuel}) is based upon ecosystem toxicity, the toxicity levels may be estimated in terms of, for instance, PDF/m² and may be measured or received from the input source 140.

When the environmental tax value (K_{fuel}) is estimated based upon financial market metrics, the costs associated with generating and delivering the electricity may be estimated based upon monetary terms as defined by financial markets.

According to an example, the environmental tax value (K_{fuel}) is a value ranging from unity depending upon the value of the resource metric. Thus, for instance, when the value of the resource metric is relatively high (such as, generating electricity from coal), the environmental tax value (K_{fuel}) is much greater than unity and when the resource metric is relatively low (such as, using photovoltaics to generate electricity), the environmental tax value is (K_{fuel}) is closer to unity. As such, the available energy required to generate and transmit electricity to the structure (A_{fuel}) may be significantly higher than the available energy (A_{DC}) supplied to the structure 104, when the environmental tax value (K_{fuel}) is relatively high.

For instance, if the resource metric is based upon exergy, the environmental tax value (K_{fuel}) is almost unity when renewable sources of energy coupled with a highly efficient power delivery scheme are implemented to supply electricity to the structure 104. On the other hand, when non-renewable sources of energy and relatively inefficient power delivery schemes are implemented to supply the electricity, the environmental tax value will be significantly greater than unity.

At step 210, the burdened cost determination module 126 determines at least one burdened cost associated with implementing the structure 104. The burdened costs associated with implementing the structure 104 may include burdening due to the power delivery infrastructure (K₁), burdening due to the cooling infrastructure (K₂), burdening due to the networking infrastructure (K₃), as well as other burdens, such as, personnel costs (K₄), IT costs (K₅) (such as, equipment, software, etc.), real estate costs (K₆), amortizations (K₇), utilizations (K₈), and other burdens (Kₙ). The total burdened costs (K_{DC}) may be denoted by a variable as follows:

K_{DC}=f(K₁, K₂, . . . Kₙ). Equation (4)

The burdened costs (K_{DC}) may include both the actual monetary costs of purchasing and operating the various infrastructures, equipment, software, etc. in the structure 104 as well as costs associated with sustainability. By way of particular example, the costs associated with the burdens (K₁-Kₙ) may include the exergy loss values of fabricating, synthesizing, operating, and/or disposing of the infrastructures, equipment, software, etc.

According to an example, the structure 104 may be synthesized, designed, and/or operated to substantially minimize the burdened costs (K_{DC}) by substantially maximizing sustainability. Various manners in which the exergy loss values may be calculated and the structure 104 may be designed and/or synthesized are disclosed in PCT Application Serial No. PCT/US07/85602 (Attorney Docket No. 200702937-1), entitled “System Synthesis to Meet an Exergy Loss Target Value”, filed on Nov. 27, 2007 and U.S. Provisional Patent Application No. 60/990,438, (Attorney Docket No. 200702978-1), entitled “Designing an Apparatus to Substantially Minimize Exergy Destruction”, filed on Nov. 27, 2007, the disclosures of which are hereby incorporated by reference in their entireties.

Thus, the burdened costs (K_{DC}) is based upon the how the structure 104 is designed. By way of example, if the structure 104 is designed to include a large amount of cooling redundancy, the burdened costs (K_{DC}) are going to be relatively higher because of the capital costs associated with providing the extra cooling. As another example, the burdened costs (K_{DC}) are going to be relatively higher in instances where the structure 104 has been designed to consume a relatively large amount of resources in at least one of the fabrication, transportation, implementation, destruction, etc., of the components 106 in the structure 104.

At step 212, the management module 132 is configured to manage the structure 104 based upon the calculated fuel available energy value. According to an example, the management module 132 is configured to manage the structure 104 based upon both the calculated fuel available energy value and the at least one determined burdened cost. Various other examples of manners in which the management module 132 is configured to manage the structure are described with respect to the following figures.

Turning now to FIG. 2B, there is shown a flow diagram of a method 220 of managing a structure 104 based upon pricing for services provided by the structure 104, according to an example. As shown in FIG. 2B, the method 220 is implemented following step 210 (FIG. 2A). In this regard, the steps contained in the method 220 may be implemented using data from the method 200.

At step 222, the total cost determination module 128 calculates a total cost of delivering an IT service through implementation of the structure 104. More particularly, the total cost determination module 128 calculates the total cost of delivering the IT service as a function of the structure available energy (A_{DC}), the fuel available energy (A_{fuel}) (which is a function of the environmental tax value (K_{fuel})), the burdened cost (K_{DC}), and a cost of electricity ($/kWh) from an electricity grid (as available from a local utility provider). An example of the cost is denoted in the following equation:

Cost=f(K_{fuel},K_{DC},A_{DC},$/kWh). Equation (5)

The function in Equation (5) is a generic function and the components thereof may thus be combined in any number of suitable arrangements. An example of a suitable arrangement is:

Cost=K_{fuel}×K_{DC}×A_{DC}×$/kWh. Equation (6)

Another example of a suitable arrangement is:

Cost=K_{fuel}×K_{DC}×A_{DC}×$/kWh. Equation (7)

As a further example, one or more of the components employed in calculating the cost function may be weighted with respect to the other cost function components. Thus, for instance, if the design of the structure 104 is more important, the burdened cost (K_{DC}) may be weighted more heavily than the environmental tax value (K_{fuel}).

At step 224, the pricing module 130 calculates pricing for services provided through implementation of the structure 104 based upon the total cost of delivering the service calculated at step 222. As such, the pricing module 130 calculates pricing for services based on the sustainability (or the environmental impact) of the structure 104 in performing the services. The pricing module 130 may also include the burdened costs associated with providing the services in calculating the pricing.

At step 212, the management module 132 outputs the pricing for services calculated at step 224. More particularly, for instance, the controller 110 may output the pricing to an output 150, such as, to display the calculated pricing, to store the calculated pricing, to communicate the calculated pricing to a computing device, etc. The management module 132 may rely upon the calculated pricing in making various management decisions for the structure 104.

For example, the management module 132 may make workload placement decisions based upon the pricing for services calculated at step 224. More particularly, for instance, the management module 132 determines which of a plurality of structures 104 should perform a service (workload) depending upon the pricing associated with implementing the structures 104 to perform the service. The selection of which of the structures 104 to be employed to perform the services based upon pricing may be defined, for instance, in service level agreements (SLAs) between the structure 104 operator and one or more clients.

In this example, the methods 200 and 220 are implemented to calculate pricing for services respectively performed by the plurality of structures 104. Based upon the pricing for the services, the management module 132 determines where the services are to be performed. Thus, for instance, the management module 132 may select a structure 104 having a relatively high pricing to perform a service for a client that is more concerned with performance of the service than maximizing sustainability in the performance of the service. On the other hand, the management module 132 may select a structure 104 having a relatively low pricing to perform a service for a client that is more concerned with minimizing environmental damage.

In addition, at step 212, the management module 132 may output the allocation of the services among the structures 104 to an output 150, such as, to display the determined service allocation, to store the determined service allocation, to communicate the determined service allocation to a computing device, etc.

As another example, the management module 132 may make decisions on whether to agree to the terms of an SLA based upon the pricing for services calculated at step 224. Thus, for instance, the management module 132 may compare the payments outlined in the SLA with the costs calculated at step 224 to determine whether the payments adequately compensate for the calculated pricing.

As a further example, the management module 132 may make decisions on when to perform services based upon the pricing calculated at step 224. In this example, the pricing may be calculated at different times of the day and night as the pricing may change due to a variety of factors. Thus, for instance, the management module 132 may schedule performance of a service during times of the day or night where the pricing is substantially minimized.

As a yet further example, the management module 132 may make decisions on whether to purchase new equipment, replace existing equipment, etc. based upon the pricing calculated at step 224.

Turning now to FIG. 2C, there is shown a flow diagram of a method 230 of managing a structure 104 to reduce at least one of the environmental tax and the burdened costs associated with implementing the structure 104, according to an example. As shown in FIG. 2C, the method 230 is implemented following step 210 (FIG. 2A). In this regard, the steps contained in the method 230 may be implemented using data from the method 200.

At step 232, the management module 132 evaluates at least one of the environmental tax value and the plurality of burdened costs to determine whether at least one of the environmental tax value and the plurality of burdened costs is capable of being reduced. The management module 132 may evaluate the reduction options based upon whether viable options for reducing the fuel available energy value and/or the burdened costs are available.

In addition, at step 212, the management module 132 may output the results of the evaluation to an output 150, such as, to display the results, to store the results, to communicate the results to a computing device, etc.

Some or all of the operations set forth in the methods 200, 220, and 230 may be contained as utilities, programs, or subprograms, in any desired computer accessible medium. In addition, the methods 200, 220, and 230 may be embodied by computer programs, which can exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

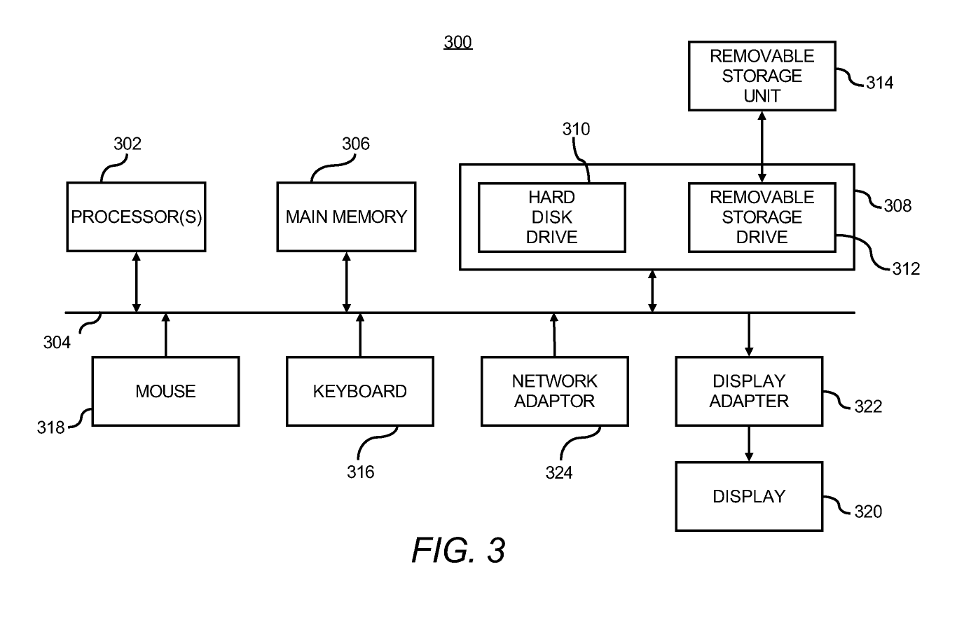

FIG. 3 illustrates a block diagram of a computing apparatus 300 configured to implement or execute the methods 200, 220, and 230 depicted in FIGS. 2A-2C, according to an example. In this respect, the computing apparatus 300 may be used as a platform for executing one or more of the functions described hereinabove with respect to the structure management apparatus 102.

The computing apparatus 300 includes a processor 302 that may implement or execute some or all of the steps described in the methods 200, 220, and 230. Commands and data from the processor 302 are communicated over a communication bus 304. The computing apparatus 300 also includes a main memory 306, such as a random access memory (RAM), where the program code for the processor 302, may be executed during runtime, and a secondary memory 308. The secondary memory 308 includes, for example, one or more hard disk drives 310 and/or a removable storage drive 312, representing a floppy diskette drive, a magnetic tape drive, a compact disk drive, etc., where a copy of the program code for the methods 200, 220, and 230 may be stored.

The removable storage drive 312 reads from and/or writes to a removable storage unit 314 in a well-known manner. User input and output devices may include a keyboard 316, a mouse 318, and a display 320. A display adaptor 322 may interface with the communication bus 304 and the display 320 and may receive display data from the processor 302 and convert the display data into display commands for the display 320. In addition, the processor(s) 302 may communicate over a network, for instance, the Internet, LAN, etc., through a network adaptor 324.

It will be apparent to one of ordinary skill in the art that other known electronic components may be added or substituted in the computing apparatus 300. It should also be apparent that one or more of the components depicted in FIG. 3 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method of managing a structure configured to perform a service, said method comprising:
determining a net power value for implementing the structure;
calculating a structure available energy value from the net power value;
calculating a fuel available energy value from the structure available energy value, wherein the fuel available energy value is a function of the structure available energy value and an environmental sustainability of the structure; and
managing the structure based upon the calculated fuel available energy value.

2. The method according to claim 1, further comprising:
determining a burdened cost associated with implementing the structure; and
wherein managing the structure further comprises managing the structure based upon the determined burdened cost.

3. The method according to claim 2, further comprising:
calculating a total cost of delivering a service through implementation of the structure as a function of the structure available energy, the fuel available energy, the burdened cost, and a cost of electricity from an electricity source.

4. The method according to claim 3, further comprising:
calculating a pricing for the service based upon the calculated total cost of delivering the service; and
wherein managing the structure further comprises outputting the calculated pricing.

5. The method according to claim 4, further comprising:
determining respective net power values for implementing a plurality of structures;
calculating respective structure available energy values of the plurality of structures from the net power values;
calculating respective fuel available energy values from the structure available energy values;
calculating respective total costs of delivering services through the plurality of structures; and
wherein calculating a pricing further comprises calculating a respective pricing for services provided through each of the plurality of structures based upon the respective total costs.

6. The method according to claim 5, wherein managing the structure further comprises managing the plurality of structures by outputting an allocation of the services among the plurality of structures according to the respective total costs and the calculated pricing.

7. The method according to claim 5, wherein managing the structure further comprises managing the plurality of structures by allocating services among the plurality of structures according to the fuel available energy values of the respective plurality of structures.

8. The method according to claim 3, further comprising:
determining a plurality of burdened costs associated with implementing the structure;
determining whether the plurality of burdened costs is capable of being reduced; and
wherein managing the structure further comprises outputting an indication that the plurality of burdened costs is capable of being reduced in response to a determination that the plurality of burdened costs is capable of being reduced.

9. The method according to claim 1, wherein the fuel available energy value is further a function of exergy and wherein calculating the fuel available energy further comprises calculating a total available energy destroyed in delivering a service through implementation of the structure.

10. The method according to claim 1, wherein the fuel available energy is based upon a financial market metric and wherein calculating the fuel available energy further comprises calculating the fuel available energy based upon values supplied from the financial market metric.

11. An apparatus for managing a structure configured to perform a service, said apparatus comprising:
a net power determination module configured to determine a net power value for implementing the structure;
a structure available energy calculation module configured to calculate an structure available energy value from the net power value;
a fuel available energy calculation module configured to calculate a fuel available energy value from the structure available energy value, wherein the fuel available energy value is a function of the structure available energy value and an environmental sustainability of the structure; and
a management module configured to manage the structure based upon the calculated fuel available energy value.

12. The apparatus according to claim 11, further comprising:
a burdened cost determination module configured to determine a burdened cost associated with implementing the structure, wherein the management module is configured to manage the structure based upon the determined burdened cost.

13. The apparatus according to claim 12, further comprising:
a total cost determination module configured to calculate a total cost of delivering a service through implementation of the structure as a function of the structure available energy, the fuel available energy, the burdened cost, and a cost of electricity from a electricity source.

14. The apparatus according to claim 13, further comprising:
a pricing module configured to calculate a pricing for the service based upon the calculated total cost of delivering the service.

15. A computer readable storage medium on which is embedded one or more computer programs, said one or more computer programs implementing a method of managing a structure configured to perform a service, said one or more computer programs comprising a set of instructions for:
determining a net power value for implementing the structure;
calculating a structure available energy value from the net power value;
calculating a fuel available energy value from the structure available energy value, wherein the fuel available energy value is a function of the structure available energy value and an environmental sustainability of the structure; and
managing the structure based upon the calculated fuel available energy value.
